(19) United States
(12) Patent Application Publication
(10) Pub. No.: US 2004/0243968 A1
(43) Pub. Date: Dec. 2, 2004

(54) System and method for software methodology evaluation and selection

(75) Inventor: David L. Hecksel, Dallas, TX (US)

Correspondence Address: Robert C. Kowert, Meyertons, Hood, Kivlin,, Kowert & Goetzel, P.C., P.O. Box 398, Austin, TX, 78767, US

(73) Assignee: Sun Microsystems, Inc., Santa Clara, CA

(21) Appl. No.: 10/445,458

(22) Filed: May 27, 2003

(51) Int. Cl. G06F 9/44

(52) U.S. Cl. 717/100

(57) ABSTRACT

System and method for evaluating and selecting methodologies for software development projects that may be used in selecting an appropriate development process (methodology) for software projects from among various methodologies. A project context for a project may be defined. Attribute values for one or more attributes of one or more components of the project context may be determined. An Agility score for the project context may be generated from the determined attribute values. In one embodiment, a project context may be scored against each candidate methodology. The Agility score may be applied to an Agility curve for the project context to determine a best-fit methodology for the project from a plurality of methodologies. In one embodiment, the plurality of methodologies may include methodologies ranging from lightweight to heavyweight methodologies. In one embodiment, the plurality of methodologies may include one or more Agile methodologies.

### BACKGROUND

1. Field of the Invention

This invention relates to computer software, and more particularly to evaluation and selection of methodologies for projects, such as software projects.

2. Description of the Related Art

In software development, there has generally existed a desire to apply engineering-level predictive standards to a discipline that tends to be governed or influenced by random and unpredictable people-driven or people-influenced behaviors and events. In the software development community, numerous methodologies have evolved for software development. A methodology is a social construction that includes the roles, skills, teaming, activities, techniques, deliverables, standards, habits and culture of an organization as it develops software A methodology may be useful in navigating through the software delivery process model. Software methodologies may fall across a range from lightweight to heavyweight methodologies. Software methodologies may include, but are not limited to, Unified Process (UP), Rational Unified Process (RUP), RUP Lite, eXtreme Programming (XP), Waterfall, Feature Driven Development (FDD) Process, and SCRUM, among others. In traditional, “heavyweight” methodologies—often referred to as Waterfall—lots of documentation tends to be created, and the project tends to flow non-iteratively (according to a project plan) similar to a series of waterfalls traversing down the side of a hill.

eXtreme Programming (XP) provides a pragmatic approach to program development that emphasizes business results first and takes an incremental, get-something-started approach to building the product, using continual testing and revision. XP proceeds with the view that code comes first. XP may be described as a “lightweight methodology” that challenges the assumption that getting the software right the first time is the most economical approach in the long run. A fundamental concept behind XP is to start simply, build something real that works in its limited way, and then fit it into a design structure that is built as a convenience for further code building rather than as an ultimate and exhaustive structure after thorough and time-consuming analysis. Rather than specialize, all team members write code, test, analyze, design, and continually integrate code as the project develops. Because there is face-to-face communication, the need for documentation is minimized.

An “Agile” Software Development community has embraced a lightweight and less restrictive (fewer rules, less documentation, etc.) way of developing software referred to as Agile methodologies. Agile methodologies may be viewed in two forms:

as an extension of XP

as a composite of other existing methodologies (lightweight, heavyweight, etc.).

Agile methodologies tends to stress, in the software development process, individuals and interactions over processes and tool, working software over comprehensive documentation, customer collaboration over contract negotiation, and responding to change over following a plan.

Feature-Driven Development, or FDD, is a programming methodology that takes advantage of recent development in architecture and modeling to implement individual software features more or less one-at-a-time. This enables a departure from the more familiar black-box development style, and allows clients and test groups to interact with individual features before the entire application has been completed. FDD relies on the fact that features have been clearly identified and prioritized by the client.

The Rational Unified Process methodology incorporates the ideas and experiences of industry leaders, partners, and of real software projects, carefully synthesized into a practical set of best practices, workflows, and artifacts for iterative software development using a fixed series of phases. RUP is similar to an online mentor that provides guidelines, templates, and examples for all aspects and stages of program development. RUP and similar products, such as Object-Oriented Software Process (OOSP), and the OPEN Process, are comprehensive software engineering tools that combine the procedural aspects of development (such as defined stages, techniques, and practices) with other components of development (such as documents, models, manuals, code, and so on) within a unifying framework.

SCRUM is an Agile Software Development Process. Scrum is an agile, lightweight process that can be used to manage and control software and product development. Wrapping existing engineering practices, including Extreme Programming, Scrum generates the benefits of agile development with the advantages of a simple implementation. Scrum significantly increases productivity while facilitating adaptive, empirical systems development. SCRUM utilizes daily meetings and organizes activities into periodic (e.g. 30 day) sprints. What many like about SCRUM is that it is not limited to software development. SCRUM may be used for any task-oriented project that has ambiguity associated with the way the work should be done.

Sun Microsystem's SunTone Architecture Methodology (SunTone AM) is an architecture-centric, iterative methodology that focuses on risk, requirements, and architecture. SunTone AM borrows the phases/terms of Inception, Elaboration, Construction, and Transition from RUP. It adds a separate architecture workflow to projects that primarily spans the inception and elaboration phases—with a particular focus on third party interfaces and non-functional requirements. After Inception, the project can apply a “best fit” design anthology (design, construction, test) depending on the needs/fit of the project.

One methodology does not fit all software development circumstances. Thus, for software developers, it may be desirable to address how to choose which methodology to select for a particular project, and to identify forces (and subsequent patterns) so that future projects can leverage prior learning.

### SUMMARY

Embodiments of a system and method for evaluating and selecting methodologies for software development projects are described. Embodiments may be used in selecting an appropriate development process (methodology) for software projects from among various methodologies including, but not limited to, RUP, RUP Lite, Extreme Programming, UP, Waterfall, Feature Driven Process, and SCRUM, among others. While embodiments are generally described herein in reference to software projects, embodiments may also be used or adapted for selecting methodologies for other types of projects.

A project context for a project may be defined. Attribute values for one or more attributes of one or more components of the project context may be determined. In one embodiment, the components may include, but are not limited to, the components include a people component, a process component, and a technology component. In one embodiment, the project context may have one or more root attributes for which values may also be determined.

An Agility score for the project context may be generated from the determined attribute values. In one embodiment, generating an Agility score for the project context from the determined attribute values may include applying one or more rules for each of the plurality of methodologies to the determined attribute values of the one or more attributes. If there are root attributes of the project context, generating an Agility score for the project context may further include applying one or more rules for each of the plurality of methodologies to the determined attribute values of the one or more root attributes. In one embodiment, the rules may include software development best practices rules. In one embodiment, generating an Agility score for the project context from the determined attribute values may include generating Agility scores for one or more pairs of the attributes, and generating the Agility score for the project context from the Agility scores of the pairs of the attributes.

The Agility score may be applied to an Agility curve for the project context to determine a best-fit methodology and/or a series of fit/misfit recommendations for the selected methodology and key alternate methodologies for the project from a plurality of methodologies. In one embodiment, the Agility curve may include a best-fit segment for each methodology. In one embodiment, the Agility curve is a normal distribution curve. In one embodiment, the plurality of methodologies may include methodologies ranging from lightweight to heavyweight methodologies. In one embodiment, the plurality of methodologies may include one or more Agile methodologies.

In one embodiment, scoring may be performed by applying the project context attributes to (pre)defined attribute representations of a set of candidate methodologies (mean, min, and max attributes, e.g. defined in methodology model files for each of the methodologies). Using this method, a best fit methodology may be obtained by scoring the project context against each of the set of methodologies' equivalent contexts (mean, min, max) and determining the best fit among the various scores.

### BRIEF DESCRIPTION OF THE DRAWINGS

FIG. 1 illustrates a project context model according to one embodiment;

FIG. 2A illustrates the normal distribution curve of Agility Scores for projects;

The distribution of these projects, when measuring their agility (via an Agility Score of a Project Context), forms a curve approximating a Normal Distribution, as illustrated in FIG. 2A.

FIG. 2B illustrates an Agility index with standard deviations according to one embodiment;

FIG. 3 illustrates a portion of an exemplary Compatibility Matrix according to one embodiment.

FIG. 4 illustrates a software methodology evaluation and selection system according to one embodiment;

FIG. 5 is a flowchart illustrating a method for evaluating and selecting methodologies for software development projects according to one embodiment;

FIG. 6A illustrates an exemplary attribute-pairing graph according to one embodiment;

FIG. 6B illustrates an exemplary attribute pairing graph that shows the minimum, mean, and maximum values that the methodology is compatible with for each attribute on the graph according to one embodiment;

FIGS. 7A and 7B illustrate another exemplary attribute-pairing graph according to one embodiment; and

FIGS. 8A and 8B illustrate an Agile Methodology distribution (Agility) curve according to one embodiment.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Embodiments of a system and method for evaluating and selecting methodologies for software development projects are described. The term “software project” or simply “project” may be used herein to denote all aspects of development for a particular piece or collection of software. A software project may include, but is not limited to, conception, design, development, testing, implementation, and maintenance aspects, each of which tends to overlap with one or more of the other aspects. Each project is unique. It may be preferable to tailor a methodology and patterns based on the project at hand. A particular methodology typically does not fit all circumstances.

Software methodology may be defined as the study of how to navigate through the software delivery process model. Embodiments may be used in selecting an appropriate development process (methodology) for software projects from among various methodologies including, but not limited to, RUP, RUP Lite, Extreme Programming, UP, Waterfall, Feature Driven Process, and SCRUM, among others. A project context, a methodology model, an Agility curve, and methodology selection patterns are described. A method for selecting a best-fit methodology for a project is described. Further, a method for extending a best-fit methodology by drawing upon compatible features (for a given project context) of other methodologies, and incompatible features of the best-fit methodology is described

Note that while embodiments are generally described herein in reference to software projects, embodiments may also be used or adapted for selecting methodologies for other types of projects.

A framework to identify forces and patterns within a project, referred to as a “project context”, is described. A project context may be defined as the environment of the project under examination. Within the project context, important elements of the environment may be determined, as well as what forces and attributes drive which decisions.

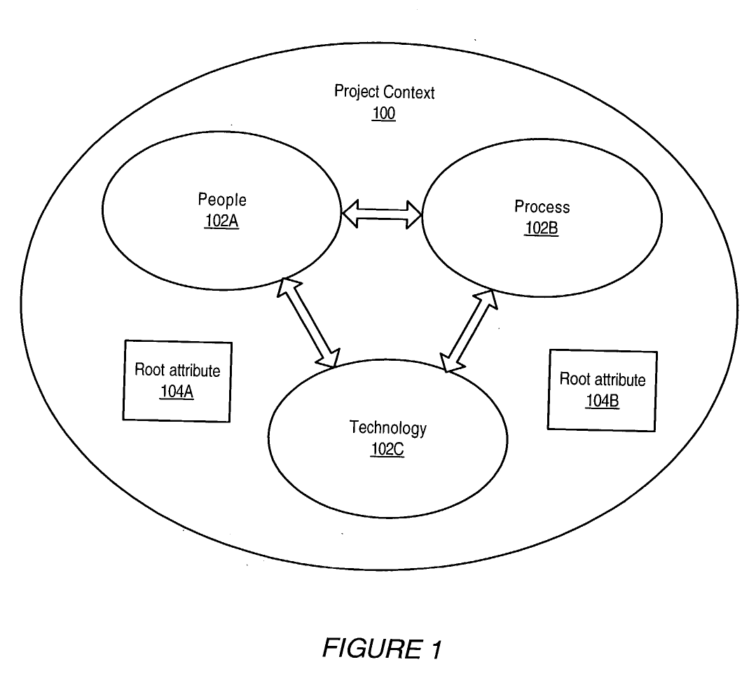

FIG. 1 illustrates a project context model according to one embodiment. In one embodiment, a project context 100 may be modeled by a set of components 102 of the project context 100 and attributes of the components 102, and possibly one or more root attributes 104 of a project. The term “project context” may be used to describe the environment that surrounds a software development project. A project context 100 may have several components 102. In one embodiment, these components 102 may include, but are not limited to, people 102A, process 102B, and technology 102C. These components 102, when used together, may preferably accurately describe the majority of the makeup and derivative behavior of a project. People 102A may influence a project's location, participation, size, etc. Process 102B may influence roles, flexibility, activities, etc. Technology 102C may influence via application complexity, “ilities”, etc. In addition, a Project may influence via root attributes such as funding, Number of entities, requirements volatility, etc.

Each component 102 may have a set of one or more attributes. An attribute may be defined as a relevant descriptive feature of a project. Attributes are influential in determining what type of methodology is appropriate for a given project. For each of these components 102 (people 102A, process 102B, and technology 102C), a set of exemplary attributes is described below. For people 102A, attributes may include one or more of, but are not limited to, size, skill level, geographic distribution, and experience-related attributes. For process 102B, attributes may include one or more of, but are not limited to, frequency of communication, experience, and schedule constraints-related attributes. For technology 102C, attributes may include one or more of, but are not limited to, complexity, number of system interfaces, and the “ilities” attributes. It should be noted that attributes may be chosen for their ability to accurately depict the makeup and environment of a successful project. Thus, the attribute's values may preferably have predictive power (e.g. via multiple regression) on the outcome (successfulness) of the project.

A project may have one or more root attributes 104, that reside at the project level rather than at the component level, and that may also be influential in a project context model. Exemplary root attributes 104 may include one or more of, but are not limited to, funding, number of entities, requirements volatility, etc. In one sense, these root attributes may themselves be collectively or individually considered a “component” of the project.

To be successful, a project may need to have the proper attribute settings, and a methodology that is compatible with those settings selected. Having a team of programmers writing random assembler statements on a scratchpad of paper is not going to significantly help the team be successful. Likewise, having a team of programmers, each isolated from one another that only communicate for an hour or so every month by phone is not going to significantly help the team be successful. The values of these attributes may be correlated to successful projects for certain methodology choices. Preferably, when the project context attribute value and the attribute from the methodology model are aligned, a greater amount of explanatory behavior of the project may be explained by the single attribute. Negative contribution to the project may occur when the project context attribute value and the methodology choice are out of alignment. Therefore, in embodiments, with the desire to have a successful outcome, the actual project attribute value(s) may be used to determine the “best” or “most explanatory” methodology value(s) based on the project attribute value(s).

The following illustrates the components of a project, and several exemplary attributes for each of the components, and is not intended to be limiting. In addition, an exemplary scoring method for each of the attributes is described. Note that these scoring methods are exemplary and are not intended to be limiting. In one embodiment, some attributes may be measured on a scale, with 1 generally being “low”, (e.g. 1-7, or 1-5; any suitable scale may be used), while other attributes may be measured by other methods, e.g. true/false or as an unscaled integer value. One or more of the attributes for each of the components 102 may be scored and used in evaluating a software project context in determining a best methodology for the project. The people 102A component may include one or more of, but is not limited to, the following attributes:

Number of geographic locations for all key and regular contributing individuals. 7-point value (1-7+).

Number of time zones involved for all key and regular contributing individuals. 7-point value (1-7+).

Accessibility of requirements providers. Will the individual(s) providing requirements be readily accessible? May be measured, for example, in latency of question asked. Answer on a 7-point scale (1-7).

Offshore component. Is there an offshore resource component for the project? May be measured as True/false

Percent of development done offshore (if true). 1-7 scale (1=low, 7=high).

Release manager experience. The experience of the release manager (a key role) as a software release manager. Experience may be measured in number of years (0-6+)—a seven-point scale.

Release manager diversity of experience. The experience or prior project diversity experience of the release manager (a key role). Measured on a seven-point scale (1-7) with 1 being low diversity, 7 being high diversity. Diversity experience may be measured by variety of prior software project experience. Repeated experience with the same or a similar type of project may be less interesting or valuable than a number of different types of project experience.

Project manager experience. The experience of the project manager (a key role) as a software project manager. Experience is measured in number of years (0-6+)—a seven-point scale.

Project manager experience diversity factor. The experience and/or prior project diversity experience of the project manager (a key role). Measured on a seven-point scale (1-7) with 1 being low diversity, 7 being high diversity. Diversity experience may be measured by variety of prior software project experience. Repeated experience with the same or a similar type of project may be less interesting or valuable than a number of different types of project experience.

Lead architect experience diversity factor. The experience and/or prior project diversity experience of the lead architect (a key role). Measured in years 0-6+. The key role position.

Size of project—the number of people on the project.

Skill level—the skill level of the composite project team. Measured from 1-7.

Senior Developer ratio—the ratio of Senior Developers (experienced, diverse individuals who can mentor, problem solve, achieve high productivity when needed, anticipate problems based on experience) on the team to non-Senior Developers. “Senior” is a skill level and aptitude, not a job title. Seven values, 0/0 to <1/7; 1/7 to <2/7; 6/7<=7/7; 5/6<6/7; 2/7<3/7; 4/7<5/7; 3/7<4/7, where these values represent increasingly valuable range values.

Teamwork—the ability of a team to work together. Measured 1-7.

Sponsoring Management Leadership—the leadership ability of the sponsoring manager. Measured from 1-7 (7-point scale).

Release Manager Leadership—the leadership ability of the release manager. Measured from 1-7 (7-point scale).

Technical Leadership—The leadership ability of the technical lead developer. Measured from 1-7 (7-point scale).

Lead Architect Leadership—the leadership ability of the lead architect on the project. Measured from 1-7 (7-point scale).

Communication index—Measured from 1-7 (1=low, 7=high). A derivative attribute.

The process 102B component may include one or more of, but is not limited to, the following attributes:

Deliverables. How many, in what form, how many are kept up to date. May be measured on a 7-point scale.

Number of mandated reviews. Is the customer requiring mandated artifact reviews, and, if so, how many? Measured 0-6+, with a minimum of 0—the project plan. If higher than 6, cap at 6.

Planned build frequency—the duration, measured in days, between product builds performed once coding activity has commenced. Measured 1-7, where:

1: >0<=1 day

2: >1 day<=2 days

3: >2 days<=3 days

4: >3 days<=4 days

5: >4 days<=5 days (1 business week)

6: >5 days<=10 days (>1 business week<=2 business weeks)

7: >10 days (>2 business weeks)

Planned usage of Tools:

Defect Tracking (true/false)

Source Management (true/false)

Project Management (true/false)

Performance testing (true/false)

Automated Testing (true/false).

Roles—Number of different unique project roles (requirements analyst, strategy, test, architect, project manager, technical facilitator, programmer, designer, tech-writer, UI Designer, etc.)

Process Owner—Person owning the process experience with a given methodology (one value per process)—each answer an integer measured in years.

Project Manager—Project manager experience with a given methodology (one value per methodology).

Release Manager—Person owning the release management responsibilities experience with a given methodology (one value per methodology).

Project plan documented (true/false).

Format of requirements—e.g. None, Use Cases, stories, neutral.

Flexible (1)—what is the overall “Flexibility” of the project environment (scale 1-7).

Flexible (2)—What is the most flexible? (Answer choices 1-3)

1: Schedule

2: Scope

3: Resources

Flexible (3)—What is the least flexible? (Answer choices 1-3)

1: Schedule

2: Scope

3: Resources

Architecture—Is it planned to have a Workflow? (True/False)

Perceived need for Architecture workflow (7-point scale)

Planned daily meetings (True/False)

The technology 102C component may include one or more of, but is not limited to, the following attributes:

Tiers—The number of estimated physical tiers in the system. Valid values 1-5+.

Distributed—Does the application utilize distributed technologies (e.g. Corba, EJB, Messaging)? (True/False).

Reusability—Are there known reusable component requirements? (True/False).

Reusability—Is this service architecture? (True/False).

Are there planned shared services being deployed with this project?

Are there re-usability requirements for this project (consume or produce)? (1=low, 7=high)

Scalability—7-point scale (1=low; 7=high).

Availability—7-point scale (1=low; 7=high).

Reliability—7-point scale (1=low; 7=high).

Maintainability—7-point scale (1=low; 7=high).

Security—Identify one or more of the following technologies that have unique security requirements:

HTTPS

Web Services

Authorization

Authentication

Data Encryption

Look at specific values, and the number of unique responses, to measure security complexity.

Complexity—the complexity of the technology used in project (1-7 scale, 1=low; 7=high).

UI-Centric—How important is the User Interface (UI) to the final delivered solution (1-7 scale; 1=low; 7=high).

Number of third party interfaces and/or integration points. (Measured 0-6. If more than 6, cap at 6).

Place or position on a technology adoption curve. Every technology has an adoption curve similar to marketing adoption curves. Some projects have more than one technology used, which would result in more than one technology adoption answer (i.e. more than one technology adoption attribute). The value for this attribute is the composite weighted adoption curve of the project. As an example, if the project is Java based, and 70% of the project is JSP/Servlet (mainstream) and 30% is Message Driven Beans (early adopter), the answer is:

$$\frac{( .7 \times mainstream value ) + ( .3 \times early adopter value )}{2}$$

In one embodiment, values may be assigned as:

Experimental: 1

Early Adopter: 2

Mainstream: 3

Late adopter: 4

In addition to these components (people 102A, process 102B, and technology 102C), there may be one or more attributes that are relevant at the root project level. Root attributes 104 may include one or more of, but are not limited to, the following. Note that these exemplary root attributes are not intended to be limiting. In addition, an exemplary scoring method for each of the attributes is described. Note that these scoring methods are exemplary and are not intended to be limiting:

Funding—e.g., measured in millions of dollars.

Business Owner/Stakeholder style. The flexibility of leadership control (e.g. controlling to non-controlling, on a scale of 1 to 7).

Business owner/Stakeholder preferences on Agility/sequencing of tasks.

Schedule time (constraint). E.g., measured in months—a release cycle.

Number Scenarios (Use cases). 1: 1-10; 2: 11-40; 3: 41-100; 4: 101-150; 5: 151-200; 6: 201-300; 7: >300.

Number of Screens as a measurement of complexity. How many screens on a local PC application or on a web application, the number of web pages (screens) the user could see within an application. On a web, the number of static and/or dynamic web pages. This counts only the primary template for dynamic screens. This may be used to measure the number of 48-hour (2 people, 3 days) work effort units. A work effort/breakdown is 2 people 3 days (estimable unit). This is applicable for GUI or non-GUI based projects. Seven point scale 1: 1-20; 2: 21-50; 3: 51-120; 4: 121-20; 5: 201-300; 6: 301-425; 7: >425.

Requirements volatility—E.g., a seven-point scale, where 1 is low/stable, 7 is high/volatile.

Database size—Number of Tables. 1: 1-100; 2: 101-200; 3: 201-300; 4: 301-500; 5: 501-700; 6: 701-1000; 7: >1000.

Database size—Number of records. 1: 1-100; 2: 101-1000; 3: 1001-10000; 4: 10001-100000; 5: 100001-1000000; 6: 1000001-10000000; 7: >10000000.

Number of Entities. 1: 1-100; 2: 101-200; 3: 201-300; 4: 301-500; 5: 501-700; 6: 701-1000; 7: >1000.

Team communication technology. Scale 1-7, in productivity/effectiveness.

Project attributes such as the exemplary attributes described above may be used to generate an Agility score or a recommended methodology (i.e. methodology compatibility). Through embodiments, matches, compatibilities and incompatibilities of projects with methodologies may be determined. In one embodiment, the highest score determined by evaluating the scores described above “wins”. Areas of compatibility and/or incompatibility may be listed for the winning methodology. In addition, areas of compatibility and/or incompatibility may be listed for other methodologies showing significant alignment and/or lack of alignment.

FIG. 9 illustrates an exemplary Methodology model according to one embodiment. A Methodology model includes the core attributes defined in a Project Context. In one embodiment, Mean, Min, and Max values are specified for each Project Context attribute. The Min and Max values define a compatibility range. In one embodiment, one set of attribute definitions (a Methodology model) exists for each Methodology (e.g., SunTone AM, SCRUM, XP, Waterfall, etc.)

The values in a Project Context model may be, for example, determined by interviewing the project team, established by customer requirements, or forecasted by the customer/project team. One or more other methods may be used to determine the values. In one embodiment, a Project Context model may include an actual project value for each attribute in the Methodology model. The following illustrates exemplary attribute entries in a Project Context model:

project.funding=900000

project.screens=12

The values in the Methodology Model may be used in identifying project and methodology alignment anomalies. The values in the Methodology Model may be used for scoring and recommendation generation The following illustrates exemplary attribute entries in a Methodology model corresponding to the exemplary Project Context model values given above:

project.funding.min=10000

project.funding.mean=500000

project.funding.max=2000000

project.screens.min=1

project.screens.mean=10

project.screens.max=30

Embodiments may provide the ability to programmatically score a project context to determine its Agility. “Agility” in a project context may include one or more of, but is not limited to, the following characteristics:

Assume Simplicity (do not over-engineer)

Embrace change

Incremental change

Rapid Feedback

Travel light (low number of artifacts)

Open communication

Continuous integration

Focus on people and communication rather than process and tools

Focus on working software rather than extensive documentation

Focus on customer collaboration rather than contract negotiation

Focus on responding to change rather than following a plan

Quick access to requirements source/validation/clarification

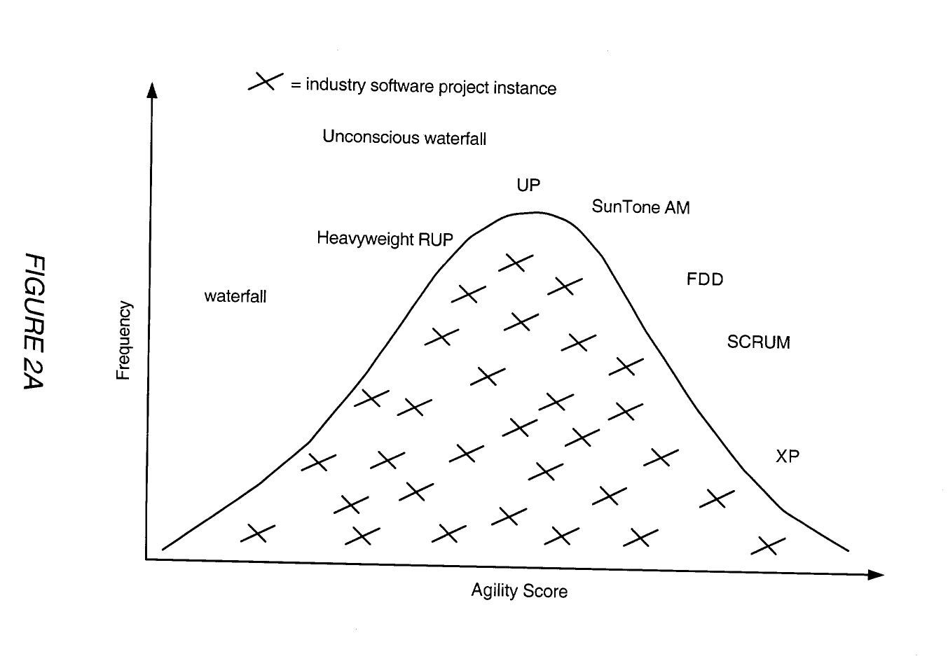

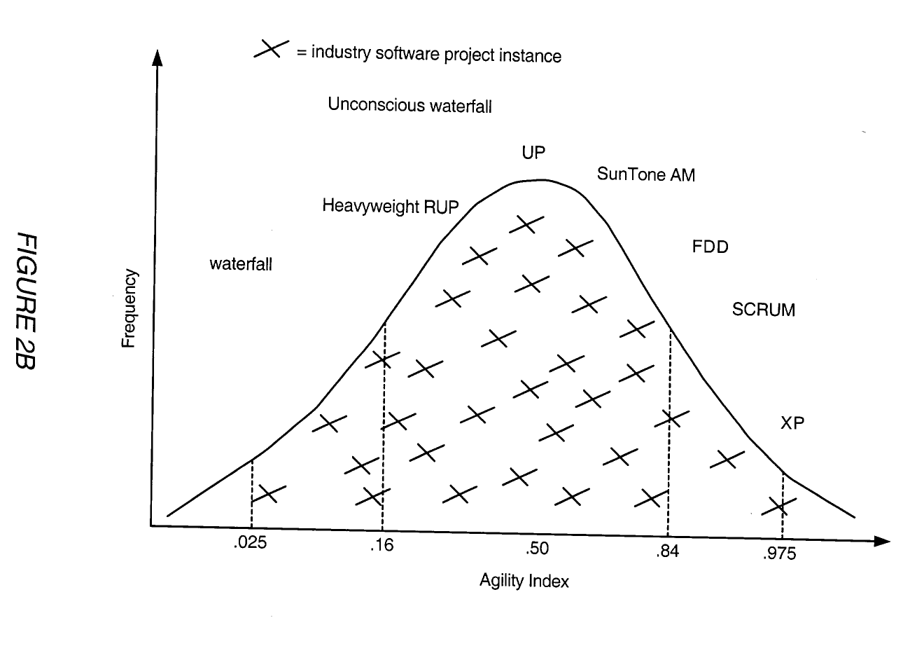

In theory, a measurement point may be generated for every software development project in the industry, or at least for a representative selection of such projects. If these points are plotted on a graph with axes of agility and frequency, a distribution curve could be seen. Some projects may be very small and agile, while others may be very large and cumbersome, while a larger number of projects fall somewhere in between these two extremes. The distribution of these projects, when measuring their agility (via an Agility Score of a Project Context), forms a curve approximating a Normal Distribution, as illustrated in FIG. 2A. Therefore, the application of concepts such as standard deviation and mean may be applied to a software project's Agility score value and placement of a project on the curve, which in turn leads to an Agility index as illustrated in FIG. 2B.

Agility index calculation (resulting from attribute scoring) may determine placement of project on the standardized Agility Curve. In the exemplary Agility Curve of FIG. 2B, for a project context score of:

0.50: project is as Agile as 50% of the industry projects (zero standard deviations)

0.975: project is as Agile as 97.5% of the industry projects (2 standard deviations)

0.84: project is as Agile as 84% of the industry projects (1 standard deviation)

0.16: −1 standard deviations

0.025: −2 standard deviations

In one embodiment, when selecting an appropriate development methodology for a project, a project may be aligned by its Agility Score, “Best Fit” Methodology Scoring and rule evaluation, one or more recommendations on methodologies, and attribute fits and misfits (also referred to as compatibilities and incompatibilities). In one embodiment, a Project context may be evaluated against a set of two or more Methodologies using their Methodology Models to determine scores for each Methodology, and the highest score “wins.”

In one embodiment, when selecting an appropriate development process for a project, the project methodology may be aligned with the project context. Through analysis, the Forces on the project may be aligned with the Attribute settings at the root project level and for the components (e.g., people, process, and technology). In one embodiment, the Forces may be aligned according to the industry “best practice” business rules and their compatibility matrices.

In one embodiment, scoring may be performed by applying the Project context (which may be gathered by interviewing the customer, through observation, by estimation, or by one or more other methods) and scoring against each of a set of two or more Methodology Models which may be pre-defined in the system (e.g. XP, RUP, SCRUM, Waterfall, Crystal, SunTone AM, UP, FDD, etc.) Each Methodology Model may include mean, min, and max values for one or more attributes appropriate for that Methodology. If an actual project context attribute value is close (aligned), positive points are awarded. If the actual project context value is not close (not aligned), a penalty is charged (points are lost). The resulting largest score of the Methodology Models vs. Project Context wins (e.g. is the most aligned).

One embodiment may include a Recommendation Engine. In addition to providing a score, one or more recommendations (e.g. in a recommendationSet) may be output during the scoring/optimal project Methodology selection process. While processing a given methodology model with the Project Context, if a significant compatibility or incompatibility is identified, a recommendation may be generated for output to the user. Compatibilities and incompatibilities may be generated not only for the “best” Methodology, but interim compatibilities and incompatibilities identified while evaluating non-winning Methodology models may also be output and/or stored for the user. In one embodiment, a recommended (highest scoring) Methodology may be recommended as well as a set of “significant” attribute compatibilities and/or incompatibilities as identified during scoring.

The following is an exemplary Recommendation output where the eXtreme Programming (XP) Methodology model wins for a given project:

Selected Methodology: Extreme Programming

Areas of Alignment: att1, att2, att3,

Warning:

Project Manager leadership may not be strong enough if adopting XP

Release Manager has insufficient experience with XP

Number of 3rd party interfaces will require special attention to Architecture up front

In one embodiment, all areas of alignment/non-alignment for all evaluated Methodology models may be viewable if desired.

One embodiment may provide predictive capabilities. In this embodiment, the Project Context under consideration may not have to be actually measured for feedback based on real values. The model may also be used on a “What if” basis. For example, if a team were putting together a team of individuals (People) for a given Project and Technology, the Recommendation Engine may be utilized for recommendations on areas of alignment/non alignment with a given “What if” scenario or proposal before the project starts. Potential problems may be identified (forecasted) up front when bidding on, sizing, or other “early” or pre-engagement type customer activities. In one embodiment, the model may be used midstream in a project to forecast what a potential change in the project context model does to the resulting set of recommendations. For example, to forecast what changing the number of scenarios and team size from 50 and 5 to 80 and 11, the model may be rerun with the new proposed data. In one embodiment, if one or more fields are left blank and marked as “generated”, the Recommendation Engine may output an appropriate value for that field(s) by selecting a value for the missing field that provides the best score for the winning Methodology model.

A general definition of a pattern is the abstraction from a concrete form which keeps recurring in specific non-arbitrary contexts. A definition of a Methodology Selection Pattern may include the notion of a general description of a recurring solution to a recurring problem replete with various goals and constraints. A Methodology Selection Pattern identifies the solution and explains why the solution is needed.

The following are exemplary project attributes, and may also be considered that drive Methodology selection based on single or multiple (combinatorial) attribute value settings:

Project Size

Skill level

Application Complexity

Leadership: Autocratic or Democratic? . . .

Communication

Schedule

Inertia

Geographic distribution

Process Experience

The following are exemplary scenarios that illustrate selecting an appropriate development process (methodology) for a project based on one or more attributes and/or forces and are not intended to be limiting. In a first scenario, forces and attributes may be determined to include a medium-sized team, a single location, an inexperienced team, and a web application. Using embodiments of the mechanism described above, a best-fit methodology may be determined to be RUP Lite. In a second scenario, the forces and attributes may be determined to include a larger team, multiple locations, an experienced team, and a distributed application. Using embodiments of the mechanism described above, a best-fit methodology may be determined to be RUP. In a third scenario, the forces and attributes may be determined to include a small team, a single location, experienced developers, and a web application. Using embodiments of the mechanism described above, a best-fit methodology may be determined to be eXtreme Programming (XP). In a third scenario, the forces and attributes may be determined to include a Large Team, Multiple Locations, an Inexperienced team, and a Distributed Application. Using embodiments of the mechanism described above, a best-fit methodology may be determined to be a heavyweight (e.g. waterfall) methodology.

In all of these exemplary scenarios, the projects may be aligned with a methodology using Agility scoring and/or best-fit methodology scoring. The project context, and its attributes, may be evaluated with the set of methodologies, and the highest score “wins”; the associated methodology is the “best fit” for the project context. The attributes of the project are determined and examined, and aligned with a matching methodology. Thus, the project methodology is aligned with the project context. In one embodiment, to accomplish this, the forces upon a project are aligned with the Attribute settings at the project level and components of the project (e.g., people, process, and technology) according to the industry “best practice” business rules and their compatibility matrices.

One embodiment may include a “Compatibility matrix” for all project context attributes of interest and their compatibility with a given Methodology. The Compatibility Matrix identifies a set of static information that is used by the methodology recommendation engine, but that also forms the foundation for a Methodology Selection Pattern Language

A Pattern Language may be defined as a structured collection of patterns that build on each other to transform needs and constraints. A pattern language may define a collection of patterns and the rules to combine them into an architectural style. A pattern language may include rules and guidelines which explain how and when to apply its patterns to solve a problem which is larger than any individual pattern can solve.

The compatibility matrix may show static alignment and/or non-alignment for a given project context attribute value and a Methodology. The compatibility matrix may include data necessary to derive single value Project Context attribute value rules. Combinatorial attributes and their settings may also form rules, and in some cases rulesets. A rule or ruleset may form a pattern in the pattern language. Attribute value transition may also show the transition from pattern to pattern in a graphical pattern language syntax. In one embodiment, the compatibility matrix and the attribute min/max/mean values set for each attribute in each methodology model file provide the data needed for the pattern language to work from.

Rules are applied against the customer Project Context and the Methodology model files. Each methodology has an associated methodology model file. The following illustrates the contents of an exemplary methodology model file, e.g. for the eXtreme Programming methodology, and is not intended to be limiting:

PROJECT.FUNDING.MIN=0

PROJECT.FUNDING.MEAN=0

PROJECT.FUN DING.MAX=0

PROJECT.BUSINESSOWNERLEADERSHIPCONTROLFLEXIBILITY.MIN=4

PROJECT.BUSINESSOWNERLEADERSHIPCONTROLFLEXIBILITY.MEAN=5

PROJECT.BUSINESSOWNERLEADERSHIPCONTROLFLEXIBILITY.MAX=7

PROJECT.SCHEDULE.MIN=1

PROJECT.SCHEDULE.MEAN=5

PROJECT.SCHEDULE.MAX=15

PROJECT.SCENARIOS.MIN=1

PROJECT.SCENARIOS.MEAN=2

PROJECT.SCENARIOS.MAX=3

PROJECT.SCREENS.MIN

PROJECT.SCREENS.MEAN

PROJECT.SCREENS.MAX

PROJECT.REQUIREMENTSVOLATILITY.MIN=1

PROJECT.REQUIREMENTSVOLATILITY.MEAN=5

PROJECT.REQUIREMENTSVOLATILITY.MAX=7

PROJECT.DATABASESIZEINTABLES.MIN=0

PROJECT.DATABASESIZEINTABLES.MEAN=40

PROJECT.DATABASESIZEINTABLES.MAX=100

PROJECT.DATABASESIZEINRECORDS.MIN=0

PROJECT.DATABASESIZEINRECORDS.MEAN=10000

PROJECT.DATABASESIZEINRECORDS.MAX=30000000

PROJECT.NUMBEROFENTITIES.MIN=1

PROJECT.NUMBEROFENTITIES.MEAN=60

PROJECT.NUMBEROFENTITIES.MAX=150

PROJECT.TEAMCOMMUNICATIONTECHNOLOGY.MIN=1

PROJECT.TEAMCOMMUNICATIONTECHNOLOGY.MEAN=3

PROJECT.TEAMCOMMUNICATIONTECHNOLOGY.MAX=7

PROJECT.PEOPLE.GEOGRAPHICLOCATIONS.MIN=0

PROJECT.PEOPLE.GEOGRAPHICLOCATION.MEANS=0

PROJECT.PEOPLE.GEOGRAPHICLOCATIONS.MAX=0

PROJECT.PEOPLE.TIMEZONES.MIN=0

PROJECT.PEOPLE.TIMEZONES.MEAN=0

PROJECT.PEOPLE.TIMEZONES.MAX=0

PROJECT.PEOPLE.ACCESSIBILITYOFREQUIREMENTSPROVIDERS.MIN=0

PROJECT.PEOPLE.ACCESSIBILITYOFREQUIREMENTSPROVIDERS.MEAN=0

PROJECT.PEOPLE.ACCESSIBILITYOFREQUIREMENTSPROVIDERS.MAX=0

PROJECT.PEOPLE.OFFSHORECOMPONENT.MIN=false

PROJECT.PEOPLE.OFFSHORECOMPONENT.MEAN=false

PROJECT.PEOPLE.OFFSHORECOMPONENT.MAX=true

PROJECT.PEOPLE.PERCENTOFFSHORE.MIN=0

PROJECT.PEOPLE.PERCENTOFFSHORE.MEAN=5

PROJECT.PEOPLE.PERCENTOFFSHORE.MAX=10

PROJECT.PEOPLE.RELEASEMANAGEREXPERIENCE.MIN=0

PROJECT.PEOPLE.RELEASEMANAGEREXPERIENCE.MEAN=0

PROJECT.PEOPLE.RELEASEMANAGEREXPERIENCE.MAX=0

PROJECT.PEOPLE.RELEASEMANAGERDIVERSITYEXPERIENCE.MIN=0

PROJECT.PEOPLE.RELEASEMANAGERDIVERSITYEXPERIENCE.MEAN=0

PROJECT.PEOPLE.RELEASEMANAGERDIVERSITYEXPERIENCE.MAX=0

PROJECT.PEOPLE.PROJECTMANAGEREXPERIENCE.MIN=0

PROJECT.PEOPLE.PROJECTMANAGEREXPERIENCE.MEAN=0

PROJECT.PEOPLE.PROJECTMANAGEREXPERIENCE.MAX=0

PROJECT.PEOPLE.PROJECTMANAGERDIVERSITYEXPERIENCE.MIN=0

PROJECT.PEOPLE.PROJECTMANAGERDIVERSITYEXPERIENCE.MEAN=0

PROJECT.PEOPLE.PROJECTMANAGERDIVERSITYEXPERIENCE.MAX=0

PROJECT.PEOPLE.LEADARCHITECTEXPERIENCE.MIN=0

PROJECT.PEOPLE.LEADARCHITECTEXPERIENCE.MEAN=0

PROJECT.PEOPLE.LEADARCHITECTEXPERIENCE.MAX=0

PROJECT.PEOPLE.SIZEOFPROJECT.MIN=1

PROJECT.PEOPLE.SIZEOFPROJECT.MEAN=10

PROJECT.PEOPLE.SIZEOFPROJECT.MAX=30

PROJECT.PEOPLE.SKILLLEVEL.MIN=0

PROJECT.PEOPLE.SKILLLEVEL.MEAN=0

PROJECT.PEOPLE.SKILLLEVEL.MAX=0

PROJECT.PEOPLE.SENIORDEVELOPERRATIO.MIN=0

PROJECT.PEOPLE.SENIORDEVELOPERRATIO.MEAN=0

PROJECT.PEOPLE.SENIORDEVELOPERRATIO.MAX=0

PROJECT.PEOPLE.TEAMWORK.MIN=0

PROJECT.PEOPLE.TEAMWORK.MEAN=0

PROJECT.PEOPLE.TEAMWORK.MAX=0

PROJECT.PEOPLE.SPONSORINGMANAGEMENTLEADERSHIP.MIN=0

PROJECT.PEOPLE.SPONSORINGMANAGEMENTLEADERSHIP.MEAN=0

PROJECT.PEOPLE.SPONSORINGMANAGEMENTLEADERSHIP.MAX=0

PROJECT.PEOPLE.RELEASEMANAGERLEADERSHIP.MIN=0

PROJECT.PEOPLE.RELEASEMANAGERLEADERSHIP.MEAN=0

PROJECT.PEOPLE.RELEASEMANAGERLEADERSHIP.MAX=0

PROJECT.PEOPLE.TECHNICALLEADLEADERSHIP.MIN=0

PROJECT.PEOPLE.TECHNICALLEADLEADERSHIP.MEAN=0

PROJECT.PEOPLE.TECHNICALLEADLEADERSHIP.MAX=0

PROJECT.PROCESS.DELIVERABLES=0

PROJECT.PROCESS.NUMBEROFMANDATEDREVIEWS=0

PROJECT.PROCESS.PLANNEDBUILDFREQUENCY=0

PROJECT.PROCESS.TOOLS=0

PROJECT.PROCESS.UNIQUEROLES=0

PROJECT.PROCESS.PROCESSOWNERPROCESSEXPERIENCEANSWERS=null

PROJECT.PROCESS.PROCESSOWNERPROCESSEXPERIENCEANSWERS.METHODOLOGY NAME.0=default

PROJECT.PROCESS.PROCESSOWNERPROCESSEXPERIENCEANSWERS.EXPERIENCE.0=0

PROJECT.PROCESS.PROJECTMANAGERPROCESSEXPERIENCEANSWERS=null

PROJECT.PROCESS.PROJECTMANAGERPROCESSEXPERIENCEANSWERS.METHODOLOGYNAME.0=default

PROJECT.PROCESS.PROJECTMANAGERPROCESSEXPERIENCEANSWERS.EXPERIENCE. 0=0

PROJECT.PROCESS.RELEASEMANAGERPROCESSEXPERIENCEANSWERS=null

PROJECT.PROCESS.RELEASEMANAGERPROCESSEXPERIENCEANSWERS.METHODOLOGYNAME.0=default

PROJECT.PROCESS.RELEASEMANAGERPROCESSEXPERIENCEANSWERS.EXPERIENCE. 0=0

PROJECT.PROCESS.PROJECTPLAN=0;

PROJECT.PROCESS.REQUIREMENTSFORMAT=UseCases

PROJECT.PROCESS.PROJECTFLEXIBILITY=0

PROJECT.PROCESS.MOSTFLEXIBLE=Scope

PROJECT.PROCESS.LEASTFLEXIBLE=Resources

PROJECT.PROCESS.ARCHITECTUREWORKFLOW=false

PROJECT.PROCESS.NEEDFORARCHITECTUREWORKFLOW=0

PROJECT.PROCESS.PLANNEDDAILYMEETINGS=false

PROJECT.TECHNOLOGY.ESTIMATEDPHYSICALTIERS=0

PROJECT.TECHNOLOGY.USESDISTRIBUTEDTECHNOLOGY=false

PROJECT.TECHNOLOGY.REUSABILITY=false

PROJECT.TECHNOLOGY.SCALABILITY=false

PROJECT.TECHNOLOGY.AVAILABILITY=false

PROJECT.TECHNOLOGY.RELIABILITY=false

PROJECT.TECHNOLOGY.MAINTAINABILITY=false

PROJECT.TECHNOLOGY.SECURITY.0=none

PROJECT.TECHNOLOGY.NUMBEROFTHIRDPARTYINTERFACES=0

PROJECT.TECHNOLOGY.PLACEONTECHNOLOGYCURVE=0

PROJECT.TECHNOLOGY.COMPLEXITY=0

PROJECT.TECHNOLOGY.UICENTRIC=0

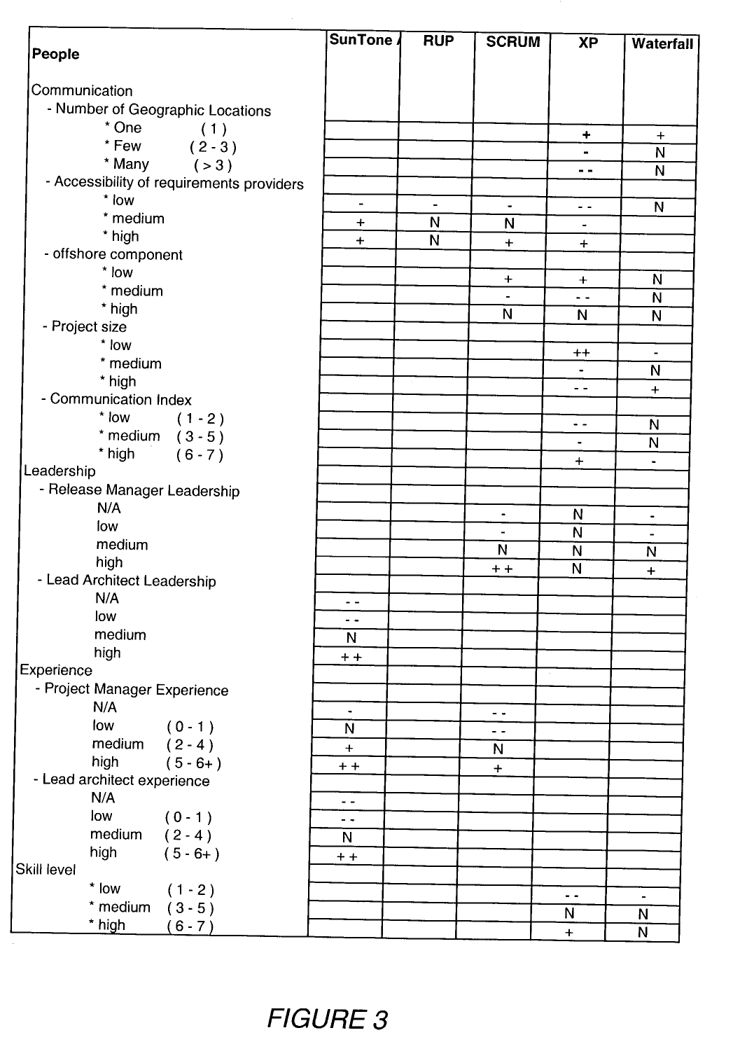

FIG. 3 illustrates a portion of an exemplary Compatibility Matrix according to one embodiment. This portion illustrates exemplary compatibilities for attributes of the “People” component for a set of exemplary Methodologies. Note that, in this example, all cells are not as yet filled in, but typically most or all cells for all candidate methodologies will be filled in. The following is a key for the symbols used in the exemplary Compatibility Matrix:

“++”—Strongly compatible

“+”—Compatible

“N”—Neither compabile nor incompatible—gives no signal/predictive power on impact to the project

“−”—Incompatible

“−−”—Strongly incompatible

In one embodiment, a compatibility matrix is a spreadsheet with Methodology types along one axis, and Methodology components (and attributes) on the other axis. In one embodiment, one embodiment, compatibility values for each attribute/methodology intersection may be found in the cells. Using the matrix, the attributes may be mapped to the Methodologies to find a value (e.g., somewhere between strongly compatible and strongly incompatible) in the cell. For example, the attribute “Skill-level” with value low is strongly incompatible with the XP methodology, whereas a high skill level is strongly compatible with XP. State transitions like that are important for the Rules in the scoring rules engine, which capture industry best practices. When multiple attributes are taken together and matrix lookups are performed to find compatibility for input to the rules engine, scoring may be based on the rule sets created for project context to methodology model data comparison and compatibility matrix state values. In another embodiment, instead of compatibility values, the cells may include penalty points.

In embodiments, distribution curves may be applied to the methodology selection of software development projects. Given a project context, the Agility values of that project context may follow a normal distribution curve, which may be referred to as an Agility distribution curve or simply Agility curve. The Agility curve may have a predictive capability, e.g. using multiple regression. Embodiments may provide the ability to programmatically score a project context for its Agility. A set of business rules (e.g. software development best practices) may be used with attribute pairings, and associated attribute dependency matrices, giving a score, rank, or measurement of applicability to a software project adopting an Agile Development methodology. A mechanism (e.g., a web-based tool or client tool) may be provided that provides the resulting score given the input of the project's components and attribute values. Embodiments may use pair-wise attributes to assess the region of Methodology compatibility to help identify where a given software project may fit from an Agility standpoint. In one embodiment, Min/Max values for an attribute may be identified or created based on the attribute pairing and/or other known best practice(s).

In one embodiment, when a compatibility exists between a project context attribute value and the methodology model, positive points are added. When an incompatibility between a project context attribute value and the methodology model exists, points are deducted. The Min/Max values may be utilized as well—penalties (higher negative values) may be applied for nearing or exceeding the Min/Max value (if a negative relationship). Additional positive points may be applied for nearing or exceeding the Min/Max value (if a positive relationship).

In one embodiment, forces and/or attributes may be grouped to identify methodologies. Forces are a set or subset of project attributes that provide a context for moving towards one methodology or another. In one embodiment, forces may be identified in the model by large point scores for a relatively few number of attributes (or combination of attributes).

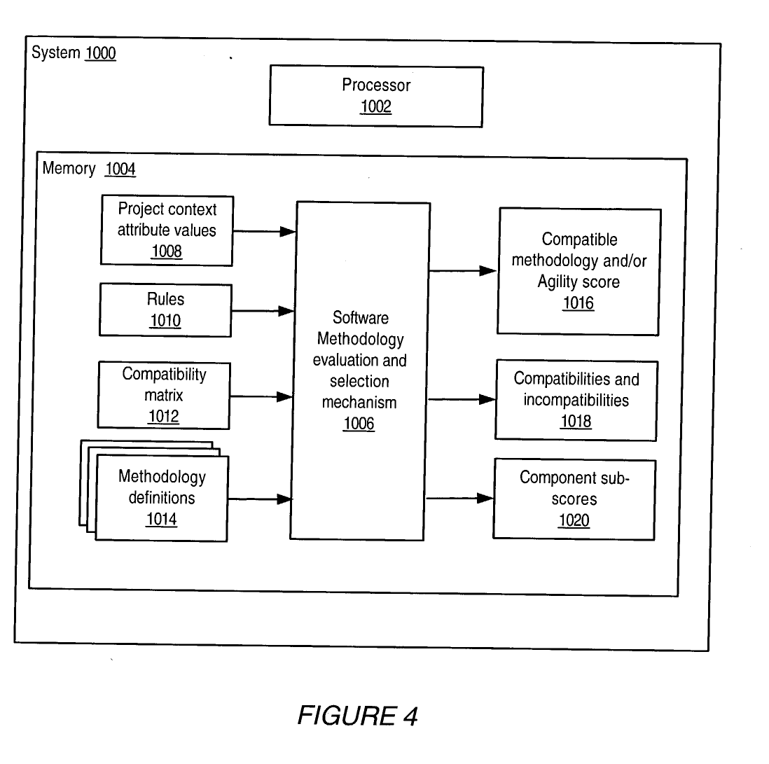

FIG. 4 illustrates a software methodology evaluation and selection system according to one embodiment. System 1000 may be any of various types of devices, including, but not limited to, a personal computer system, desktop computer, laptop or notebook computer, mainframe computer system, workstation, network computer, or other suitable device. System 1000 may include at least one processor 1002. The processor 1002 may be coupled to a memory 1004. Memory 1004 is representative of various types of possible memory media, also referred to as “computer readable media.” Hard disk storage, floppy disk storage, removable disk storage, flash memory and random access memory (RAM) are examples of memory media. The terms “memory” and “memory medium” may include an installation medium, e.g., a CD-ROM or floppy disk, a computer system memory such as DRAM, SRAM, EDO RAM, SDRAM, DDR SDRAM, Rambus RAM, etc., or a non-volatile memory such as a magnetic media, e.g., a hard drive or optical storage. The memory medium may include other types of memory as well, or combinations thereof. System 1000 may couple over a network to one or more other devices via one or more wired or wireless network interfaces (not shown).

System 1000 may include, in memory 1004, a Software Methodology evaluation and selection mechanism 1006 that may be used to evaluate a project's determined attribute values using one or more rules 1010 to generate an Agility score and/or to determine a compatible methodology 1016 for a project and/or areas of compatibility and incompatibility recommendations. System 1000 may also include one or more display devices (not shown) for displaying outputs of Software Methodology evaluation and selection mechanism 1006 and/or one or more user input devices (e.g. keyboard, mouse, etc.; not shown) for accepting user input to Software Methodology evaluation and selection mechanism 1006.

The components and attributes described above may serve as a model of a project. The model, and its determined attribute compatibility scores, may be used by Software Methodology evaluation and selection mechanism 1006 to determine an overall “best fit” methodology and/or Agility score 1016 as well as a status description and a list of recommendations, compatibilities and incompatibilities. The Model may also be used for problem prediction—forces out of alignment with the “best fit” methodology choice and what will occur in the future with that project should nothing correctively be done. The Model and Software Methodology evaluation and selection mechanism 1006 may be implemented in any of a variety of programming languages, such as the Java Programming language. Other programming languages than Java may be used.

The following describes means for generating an Agility score and/or determining a compatible methodology for a project context from attribute values for one or more attributes of one or more components of the project context. In one embodiment, an Agility score, recommended methodology, and/or output of compatibilities/incompatibilities may be generated by analyzing the Project Context (using its determined attribute values 1008) using a set of rules 1010 that represent best practices and community body of knowledge about what works or does not work. “Rule” as used here refers to a named entity that represents one or more constraints. A Rule Set is a named entity representing two or more rules. Rules may be written or defined for purposes including, but not limited to:

Project Context Attribute values/Attribute value combinations (for Agility index scoring and methodology recommendation)—determines Agility index for subsequent Agility curve placement.

Project Context Attribute values/Attribute(s) value(s) combinations versus the Methodology Min/Mean/Max values to evaluate Methodology compatibility.

The following are examples of rules, and are not intended to be limiting. An exemplary rule, for example named “Small_Project”:

$$\frac{If ( SizeOfProject < 15 )}{constraint}$$

An exemplary rule, for example named “Geographic_Mismatch”:

$$\frac{If ( SizeOfProject < 15 )}{constraint} \&\& \frac{( NumberOf Timezones > 1 )}{constraint}$$

In one embodiment, a rule set may be formed by combining two or more rules via an operator or operators. In one embodiment, some rules may be static rules (e.g. best practices and/or community knowledge rules). In one embodiment, extensions may be added to rules via user-defined rules or a rule management mechanism. In one embodiment, a format for rules may be:

attribute % operator % domain % data_type % Component

where:

attribute: corresponds to an attribute name

operator: logical or arithmetic operator applied to Expression

domain: value used for operation against attribute

data_type: e.g. String, Int, Double

Applying this rule format to the “Small_Project” exemplary rule:

Small_Project=AND:sizeOfProject%<%15%Int%People

Small_Project.penalty=2 (2 points/person over the limit)

Applying this rule format to the “Geographic_Mismatch” exemplary rule:

Geographic_Mismatch=AND:sizeOfProject%<%15%Int%PeopleltimeZones%>%1%Int%People

Geographic_Mismatch.penalty=50 (50 point fixed penalty for mismatch of geographic configuration)

In one embodiment, rules 1010 such as the exemplary rules described above may be included in a property file or other format (e.g., XML, SQL database, etc.). In another embodiment, rules 1010 may be hard-coded in Software Methodology evaluation and selection mechanism 1006. In yet another embodiment, a combination of rules within one or more files or other format and hard-coded rules may be used as input to Software Methodology evaluation and selection mechanism 1006.

Methodology rules may be added to capture learning as the software development community understands software definition, creation, and delivery better and new best practices are understood and confirmed. Learning may occur in different ways including one or more of, but not limited to: local usage; and accessing a potentially remote data source that receives the project context data for each person “scoring” a project. Learning can occur by examining trends of the centralized data, and updating its rules based on existing or new industry trends.

In one embodiment, one or more derivative or composite attributes may be defined out of one or more other attributes and/or rules. Rules may be written on derivative attributes, provided there are no circular references. One example of derivative attributes form a family of data that may be referred to as Communication indexes. A communication index becomes a derivative (intermediate) attribute of the Project Context. Communication is the lifeblood of a software project. Any inhibitor to communication, whether it be two developers 15 feet across the room and a cubicle wall in the way, or 5,000 miles separating the developer and the business requirements provider, communication within a project is critical to success. Communication is mostly in the “People” Component, but there is an offsetting Technology component attribute (Communication Technology) which may mitigate the risk of some of the “people” Communication barriers existing for a project. Derivative or composite attributes may be strong data, and typically have significant predictive power. Derivative attributes may be good candidates for Patterns since they may convey multiple attribute data.

One embodiment may include one or more project context data attribute files that describe which data is part of a project context. Determined attribute values 1008 may be included in the project context data attribute files. In one embodiment, the Java “property” file format may be used, but the data may be implemented in XML, a relational database, or other suitable format. The data files describe the association of the respective attribute with its parent component (People, Process, Technology, Project root).

In one embodiment, one or more of rules 1010 may be evaluated using determined attribute values 1008 to generate a final Agility index. The following may be used to determine the Agility curve translation:

$$Agility Curve Translation = \frac{AgilityScore}{MaximumScore}$$

where MaximumScore is the highest possible score. This generates a value between 0 and 1 (which may be converted to a percentage) for placement on an Agility curve. In one embodiment, standard deviation=1, and mean=0.5. Alternatively, the following may be used to determine the Agility curve translation:

$$Agility Curve Translation = \frac{AgilityScore}{Learned Agility Score}$$

In one embodiment, there may be one or more Methodology definitions 1014 as input to Software Methodology evaluation and selection mechanism 1006, which may be implemented as Methodology definition files. In one embodiment, a Methodology definition file may describe the Methodology attribute settings, along with their minimum and maximum “tolerable” values for the attributes. Each Methodology definition may be evaluated using rules 1010, which may be hard coded rules, rules defined in one or more input rules files, or a combination thereof. The rules 1010 are at a higher level than the Methodology, and may be considered a wrapper of the Methodology. The rules 1010 may be used to look at the attributes and to drive the Methodology, but are not part of the Methodology itself. A set or a portion of a set of rules may be used for more than one Methodology. Exemplary rules may include “project management experience <2 years” and “data base size >40”. A rule or rules may be used to determine a subset of methodologies that may be applicable for that rule or rules. In one embodiment, rules 1010 are applied to determined attribute values to determine one or more Methodologies that may be applicable to a project.

In one embodiment, a predefined compatibility matrix 1012 may be input or alternatively hard-coded into Software Methodology evaluation and selection mechanism 1006. The rules 1010 may work using the compatibility matrix 1012.

Available data for rules in the Methodology definitions 1016 may include, but is not limited to, the min, mean, and max values for each attribute. In one embodiment, the highest score wins (fewer penalties). Best-Fit segments (min/max ranges) may be identified, and may be stored for later presentation. Compatibilities and/or incompatibilities may be captured and stored for later reporting uses for one or more of the Methodologies.

The components and attributes described above may serve as a Model of a project. The Model, and its determined attribute compatibility scores, may be used to determine an overall “best fit” methodology as well as a status description and list of recommendations. The Model may also be used for problem prediction—forces out of alignment with the “best fit” methodology choice and what will occur in the future with that project should nothing correctively be done.

Output of the Software Methodology evaluation and selection mechanism 1006 may include an Agility score and/or one or more compatible methodologies. In one embodiment, a best-fit compatible methodology may be determined and output. In one embodiment, a set of potential compatible methodologies may be output. In one embodiment, an Agility score may be generated and used to determine one or more candidate methodologies. One embodiment may generate both an Agility score and one or more compatible methodologies.

In one embodiment, sub-scores 1020 of the Agility score for one or more components (e.g. people, process, and technology) may also be determined. These may include, but are not limited to, a people sub-score, a process sub-score, and a technology sub-score.

In one embodiment, based on the Agility score 1016, rulesets, Project Context, methodology models, and/or a compatibility matrix, a set of areas of compatibility and/or a set of areas of incompatibility 1020 may be generated for a determined compatible methodology. For example, if extreme programming is selected as a methodology based on the Agility score or recommended methodology, a set of one or more areas that received negative scores (incompatibilities) for the determined methodology may be generated. This may serve to make the decision-makers aware of areas of compatibility and incompatibility for a determined methodology.

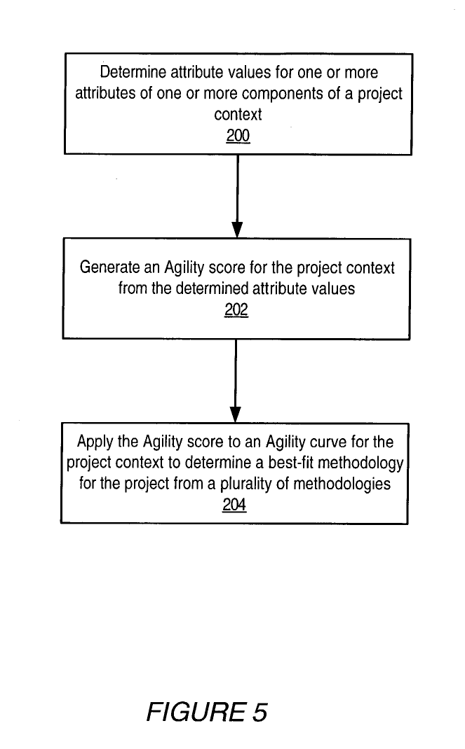

FIG. 5 is a flowchart illustrating a method for evaluating and selecting methodologies for software development projects according to one embodiment. A project context for a project may be defined. As indicated at 200, attribute values for one or more attributes of one or more components of the project context may be determined. In one embodiment, a project assessment, which may involve an interview process, may be used to determine one or more of the attribute values. Project funders, business owners, programmers, etc. may be interviewed during the project assessment. In one embodiment, the components may include, but are not limited to, the components include a people component, a process component, and a technology component. In one embodiment, the project context may have one or more root attributes for which values may also be determined.

As indicated at 202, an Agility score for the project context may be generated from the determined attribute values. One embodiment may use rules and rule sets to calculate an Agility score for the project context. In one embodiment, rules and rule sets may be used to compare the project context with a set of methodologies and predefined information to calculate compatibility scores for each methodology. In one embodiment, generating an Agility score for the project context from the determined attribute values may include applying one or more rules for each of the plurality of methodologies to the determined attribute values of the one or more attributes. If there are root attributes of the project context, generating an Agility score for the project context may further include applying one or more rules for each of the plurality of methodologies to the determined attribute values of the one or more root attributes. In one embodiment, the rules may include software development best practices rules. In one embodiment, generating an Agility score for the project context from the determined attribute values may include generating Agility scores for one or more pairs of the attributes, and generating the Agility score for the project context from the Agility scores of the pairs of the attributes.

In one embodiment, sub-scores of the Agility score for one or more components (e.g. people, process, and technology) may also be determined. These may include, but are not limited to, a people sub-score, a process sub-score, and a technology sub-score.

As indicated at 204, the Agility score may be applied to an Agility curve for the project context to determine a best-fit methodology for the project from a plurality of methodologies. In one embodiment, from the scores generated in 202, the “best fit” methodology may be determined for the project context. In one embodiment, as a cross check, the agility score may be applied to the agility curve to determine a best fit methodology for the project. In one embodiment, the Agility curve may include a best-fit segment for each methodology. In one embodiment, the Agility curve is a normal distribution curve. In one embodiment, the plurality of methodologies may include methodologies ranging from lightweight to heavyweight methodologies. In one embodiment, the plurality of methodologies may include one or more Agile methodologies.

In one embodiment, a compatibility and incompatibility output may also be generated. Based on the Agility score, a methodology may be selected, and a set of areas of compatibility and a set of areas of incompatibility, if any, may be generated for the methodology. In one embodiment, one or more areas of compatibility and/or incompatibility for the best fit methodology with the project may be generated. In one embodiment, compatibility and/or incompatibility information for one or more others of the methodologies with the project may be generated.

The following is an example of applying a scoring process according to one embodiment. The project may be scored against two or more methodology models and compatibility matrix data for the methodologies. Exemplary methodologies may include one or more of, but are not limited to, eXtreme Programming, RUP, and SunTone AM. For each scored methodology, one or more rules and/or rule sets may be applied to generate fit/misfit (compatibility/incompatibility) data. A score for each methodology may be generated from a corresponding methodology model file. The best (most compatible) score may be selected to determine a recommended methodology.

In one embodiment, during the above process, an Agility score may also be calculated. The agility score may be compared to an Agility curve using a process such as that illustrated in FIG. 5 to generate a recommended methodology. The recommended methodology generated using the scoring process generated above and the placement of the Agility score on the Agility curve to determine a recommended methodology preferably generate the same methodology as a recommended methodology.

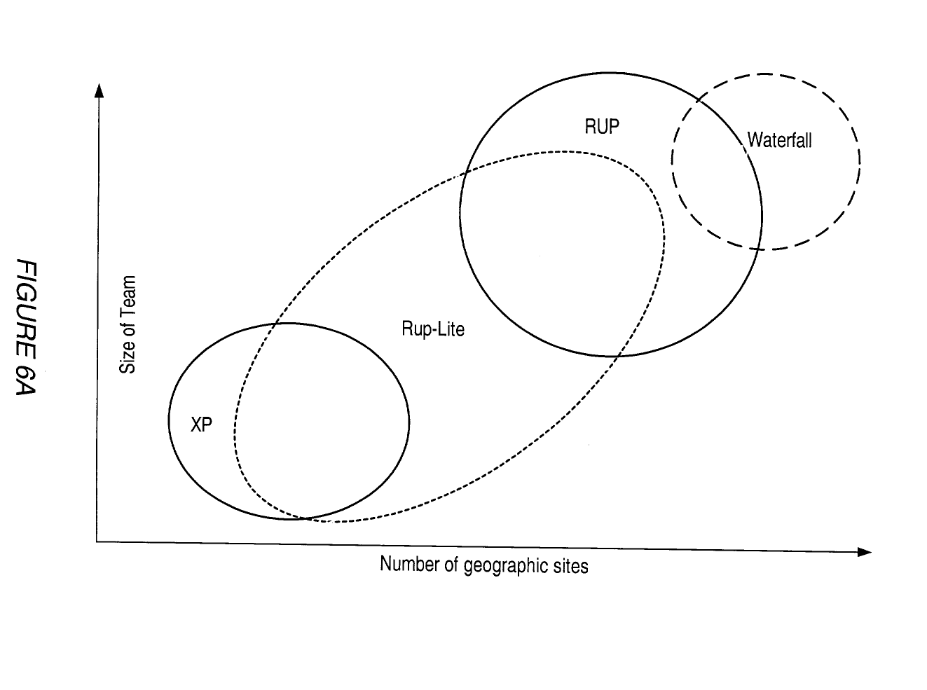

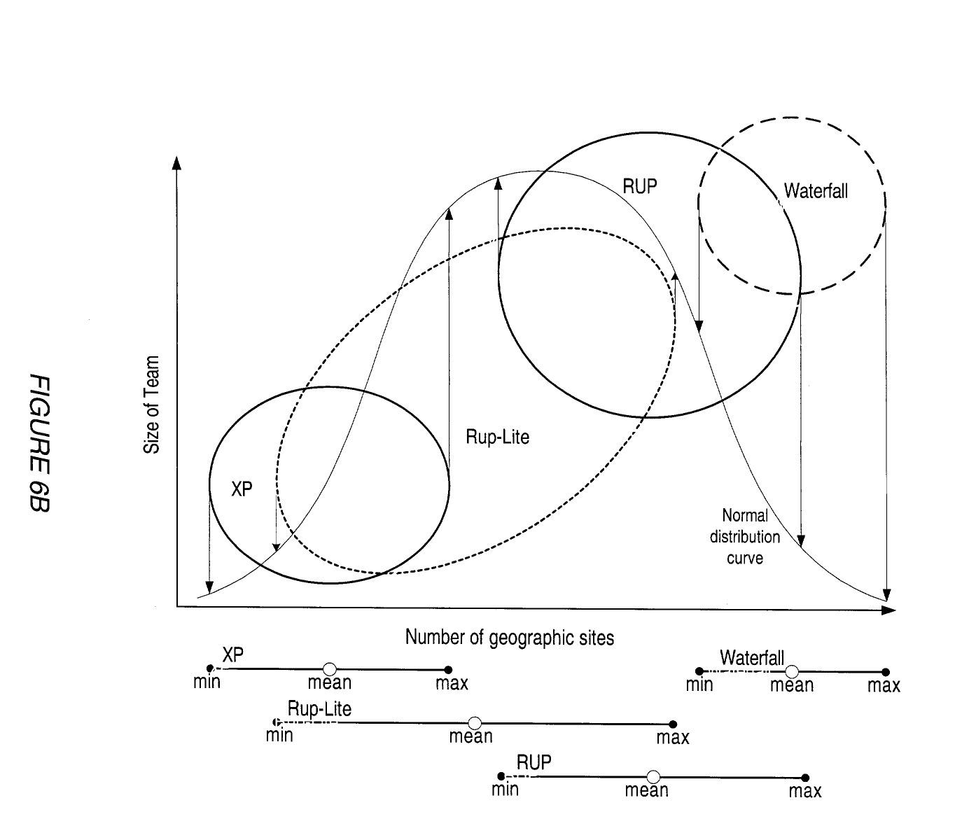

FIGS. 6A and 6B illustrate an exemplary attribute-pairing graph according to one embodiment. Attributes may be paired on a graph. In this example, the size of the team and the number of geographic sites are paired. FIG. 6B illustrates an exemplary attribute pairing graph that shows the minimum, mean, and maximum values that a methodology is compatible with for each attribute on the graph according to one embodiment FIG. 6B illustrates determining a normal distribution curve overlay of FIG. 6A according to one embodiment. FIG. 6B also illustrates, below the X axis (in this example, the Number of geographic sites axis), compatibility range segments of the normal distribution curve that each particular methodology is compatible with. A compatibility range segment is a segment of the normal curve determined by drawing vertical lines from the leftmost and rightmost edges of a methodology bubble. Compatibility range segments for two or more methodologies may overlap. As illustrated, each compatibility range segment includes a min, mean, and max possible values of a methodology for the attribute on the X axis.

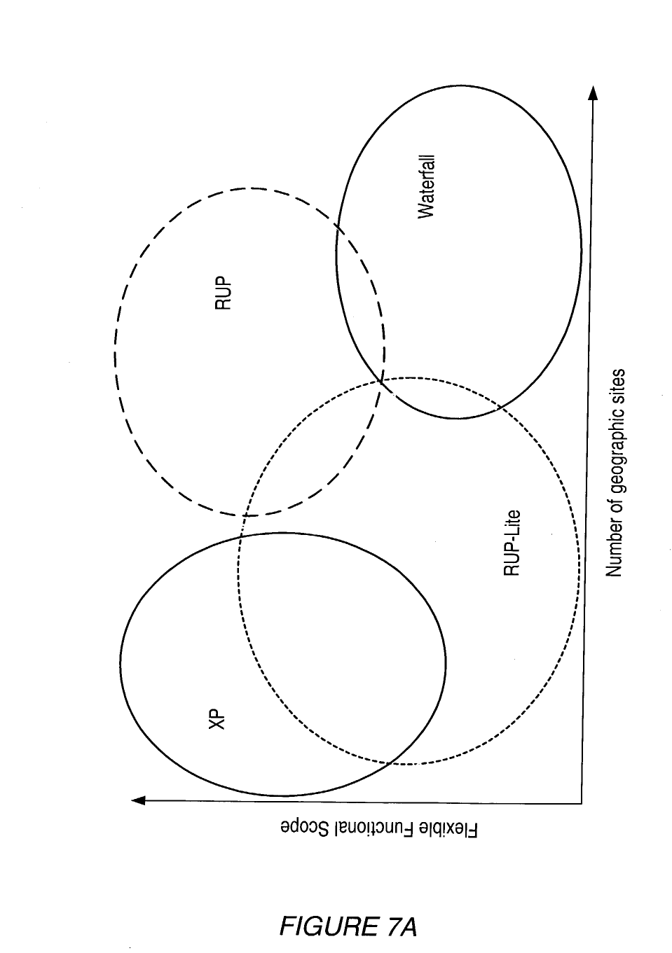

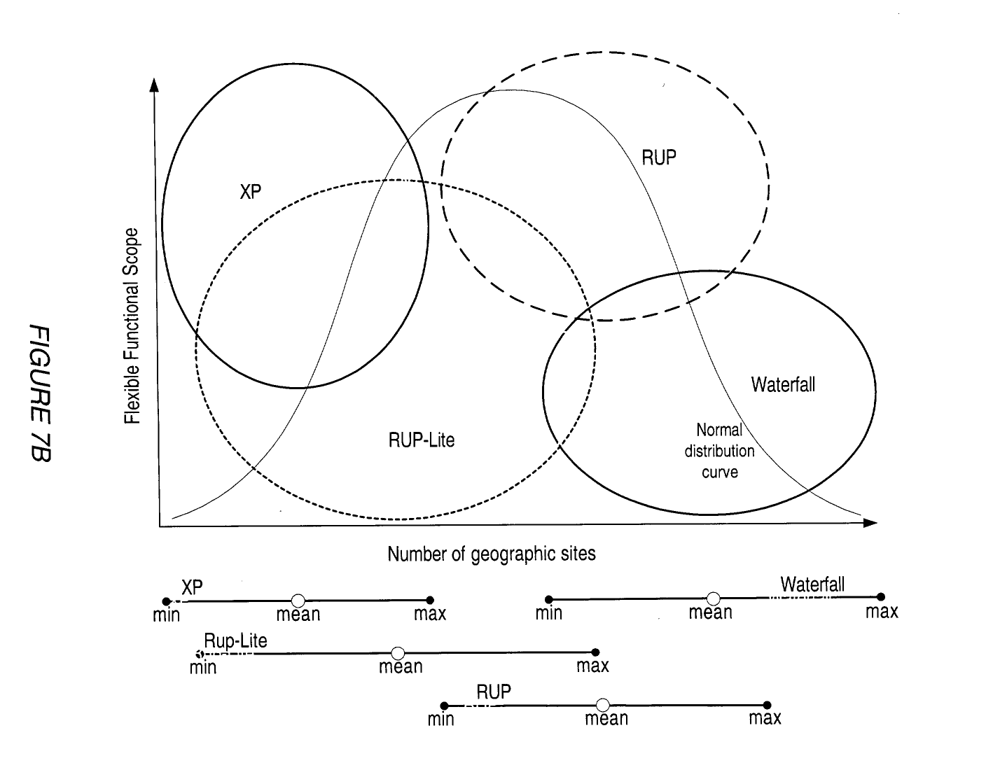

FIGS. 7A and 7B illustrate another exemplary attribute-pairing graph according to one embodiment. In this example, flexible functional scope and number of geographic sites are paired. FIGS. 6B and 7B further illustrate the Agility distribution curve and methodology compatibility segments of the Agility distribution curve superimposed on the graphs. One or more attribute-pairing graphs may be used to determine in which methodology region a given project resides. The attribute pairing graph may be used as the source of the “scores” used in the analytical model (either discrete values, or values assigned to general compatibility ranges such as “bad”, “ok”, “good”, “best practice” and/or an enumerated value which might be proxy for those range descriptions in text). The model consists of the summation of all key attribute-pairing results compared to the proposed Methodology being scored. In one embodiment, the min, mean, and max values in each of the Methodology models may be determined by looking at vertical lines coming down from the methodology regions (left=min, middle=mean, right=max). FIG. 7B shows, below the X axis (in this example, the Number of geographic sites axis), compatibility range segments of the normal distribution curve that each particular methodology is compatible with. A compatibility range segment is a segment of the normal curve determined by drawing vertical lines from the leftmost and rightmost edges of a methodology bubble. Compatibility range segments for two or more methodologies may overlap. As illustrated, each compatibility range segment includes a min, mean, and max possible values of a methodology for the attribute on the X axis.

Attributes may be paired on a graph such as the exemplary graphs of FIGS. 6A and 6B and FIGS. 7A and 7B, and which methodology region a project is in may be identified on the attribute pairing graph, as illustrated in FIGS. 6B and 7B. Note that the methodologies illustrated on FIGS. 6A-6B and FIGS. 7A-7B are exemplary methodologies and are not intended to be limiting. The compatibility region for a given methodology defined in an attribute-pairing graph provides a minimum and maximum value for each attribute (one attribute on the X axis, one attribute on the Y axis), and may be used to determine that a methodology is a “better fit” for that given attribute. These “attribute pairing” graphs can feed the model for providing minimum, mean, and maximum attribute values that are compatible for a given methodology. (See FIG. 9).

Given the above, a methodology definition has minimum, mean, and maximum values of attributes relevant to a project context. Thus, just like a project context can be scored for Agility and placement on the agility curve, each of the three values (minimum, mean, and maximum) may be determined and, using the same value (e.g. minimum), across all attributes, generate a series of attributes and attribute values that looks very similar to a Project Context set of attributes and values. Therefore, for a Methodology definition (min, mean, max compatible attribute values), the set of all minimum values for all attributes in that Methodology definition may be fed into the Agility scoring mechanism to generate a minimum Agility score (most Agile) for that Methodology. The same can be done for the mean and maximum values to generate a Mean (average agility) and maximum (least agile) score. This assumes that the same Agility scoring mechanism used for a project context can be used for a Methodology (both have a common set of Attributes).

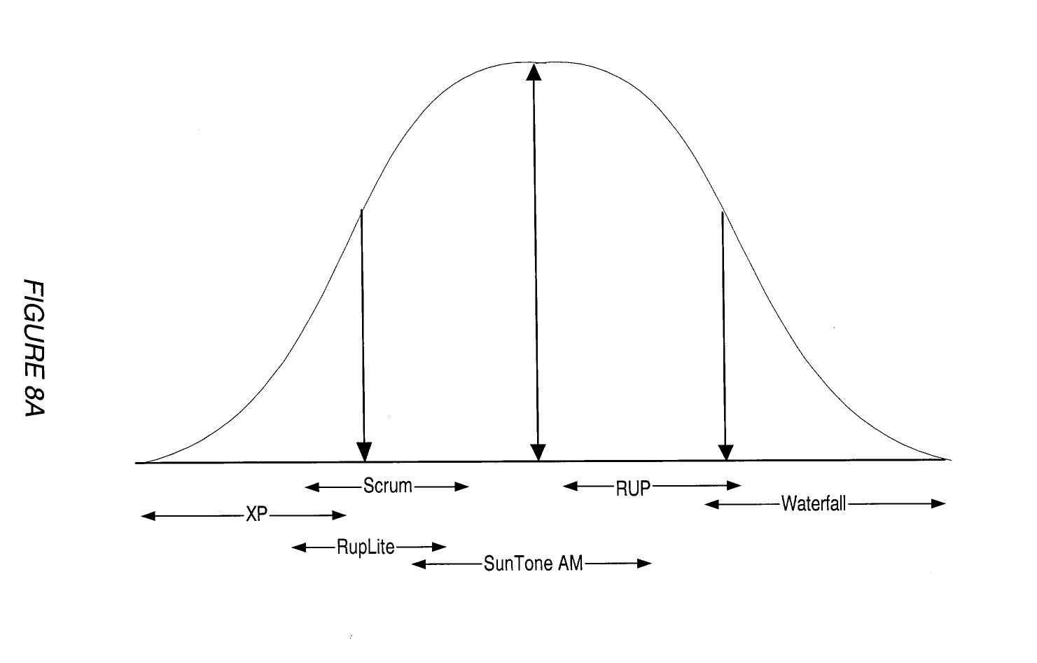

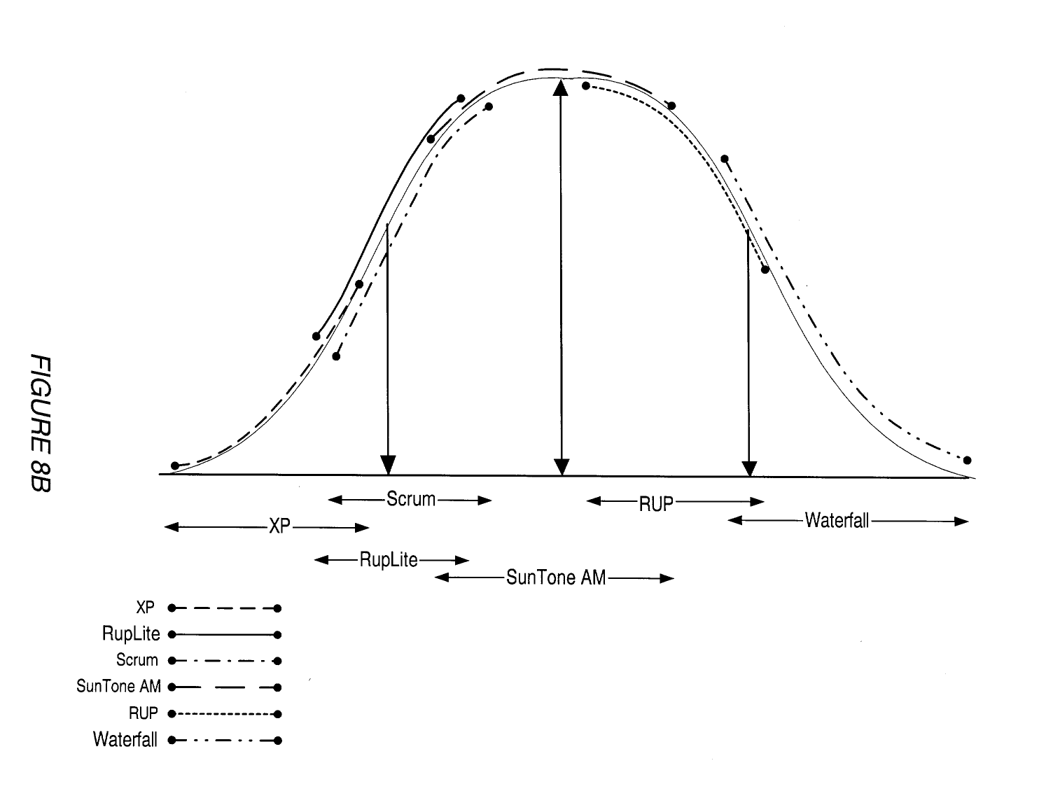

FIGS. 8A and 8B illustrate an Agile Methodology distribution (Agility) curve according to one embodiment. FIGS. 8A and 8B may represent means for applying the Agility score to an Agility curve for the project context to determine a best-fit methodology for the project from a plurality of methodologies. FIG. 8A illustrates an Agility curve with normal distribution, and related to scoring, according to one embodiment. FIG. 8B illustrates an Agility curve with normal distribution, and shows best-fit segments (summation of compatibility segment analysis across all attributes) according to one embodiment. In one embodiment, for an Agile Methodology distribution curve, software development projects have, or are assigned, a distribution between heavyweight and lightweight methodologies that follows a standard “normal” distribution curve, with ultra lightweight being on one end and ultra heavyweight being on the other end. Segments of the curve (say ultra light to moderate light) are also normally distributed. Thus, standard normal distribution percentages may be stated and used as assumptions when examining a particular project. 34% of projects, being “heavier weight” than mean agility, will fall within one standard deviation of mean, 68% of all projects will fall within one standard deviation (plus or minus).

Note that FIGS. 7B and 8B differ in that FIG. 7B has compatibility segments for one attribute of a project context/methodology model, while FIG. 8B represents the summation of Figures such as FIG. 7B for all attributes in the model.

The Agility curve is the visual presentation of the Agility score calculated for a particular project context. For a project context, an agility score may be calculated that provides an exact point on the agility curve. For a Methodology, minimum and maximum values may provide a segment of “best fit” compatibility on the Agility curve. The point of the particular project context on the agility curve, and the segments on the agility curve, may be examined to determine which methodologies are fits or close fits and those that are not.

A methodology may also be scored in a similar manner to a project context if using the mean values, treating the Methodology as an abstract conglomerate of compatible attribute values. A Methodology model file (the same data as a project context file) may be scored to generate an Agility score and index for the Methodology model file.

### CONCLUSION

Various embodiments may further include receiving, sending or storing instructions and/or data implemented in accordance with the foregoing description upon a carrier medium. Generally speaking, a carrier medium may include storage media or memory media such as magnetic or optical media, e.g., disk or CD-ROM, volatile or non-volatile media such as RAM (e.g. SDRAM, DDR SDRAM, RDRAM, SRAM, etc.), ROM, etc. As well as transmission media or signals such as electrical, electromagnetic, or digital signals, conveyed via a communication medium such as network and/or a wireless link.

The various methods as illustrated in the Figures and described herein represent exemplary embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A method, comprising:
determining attribute values for one or more attributes of one or more components of a project context of a project;
generating an Agility score for the project context from the determined attribute values; and
applying the Agility score to an Agility curve for the project context to determine a best-fit methodology for the project from a plurality of methodologies.

2. The method as recited in claim 1, further comprising scoring the project context against each of the plurality of methodologies.

3. The method as recited in claim 1, wherein said generating an Agility score for the project context from the determined attribute values comprises scoring the project context against each of the plurality of methodologies according to a compatibility matrix.

4. The method as recited in claim 1, further comprising generating compatibility and incompatibility information for each of the plurality of methodologies with the project.

5. The method as recited in claim 1, further comprising determining one or more areas of compatibility and incompatibility with the project for the determined best-fit methodology.

6. The method as recited in claim 1, wherein the components include a people component, a process component, and a technology component.

7. The method as recited in claim 1, wherein said generating an Agility score for the project context from the determined attribute values comprises applying one or more rules for each of the plurality of methodologies to the determined attribute values of the one or more attributes.

8. The method as recited in claim 7, wherein the rules include software development best practices rules.

9. The method as recited in claim 7, further comprising:
determining attribute values for one or more root attributes of the project context; and
wherein said generating an Agility score for the project context from the determined attribute values further comprises applying the one or more rules for each of the plurality of methodologies to the determined attribute values of the one or more root attributes.

10. The method as recited in claim 1, wherein said generating an Agility score for the project context from the determined attribute values comprises:
generating Agility scores for one or more pairs of the attributes; and
generating the Agility score for the project context from the Agility scores of the pairs of the attributes.

11. The method as recited in claim 1, wherein the project is a software development project.

12. The method as recited in claim 1, wherein the Agility curve includes a best-fit segment for each methodology.

13. The method as recited in claim 1, wherein the plurality of methodologies includes methodologies ranging from lightweight to heavyweight methodologies.

14. The method as recited in claim 1, wherein the plurality of methodologies includes one or more Agile methodologies.

15. The method as recited in claim 1, wherein the Agility curve is a normal distribution curve.

16. A system comprising:
a processor; and
a memory comprising program instructions, wherein the programming instructions are executable by the processor to:
generate an Agility score for a project context of a project from attribute values for one or more attributes of one or more components of the project context; and
apply the Agility score to an Agility curve for the project context to determine a best-fit methodology for the project from a plurality of methodologies.

17. The system as recited in claim 16, wherein the programming instructions are further executable by the processor to score the project context against each of the plurality of methodologies.

18. The system as recited in claim 16, wherein, to generate an Agility score for the project context from the determined attribute values, the programming instructions are further executable by the processor to score the project context against each of the plurality of methodologies according to a compatibility matrix.

19. The system as recited in claim 16, wherein the programming instructions are further executable by the processor to generate compatibility and incompatibility information for one or more of the plurality of methodologies with the project.

20. The system as recited in claim 16, wherein the programming instructions are further executable by the processor to determine one or more areas of compatibility and incompatibility with the project for the determined best-fit methodology.

21. The system as recited in claim 16, wherein the components include a people component, a process component, and a technology component.

22. The system as recited in claim 16, wherein, to generate an Agility score for the project context from the attribute values, the programming instructions are further executable by the processor to apply one or more rules for each of the plurality of methodologies to the attribute values of the one or more attributes.

23. The system as recited in claim 22, wherein the rules include software development best practices rules.

24. The system as recited in claim 22, wherein, to generate an Agility score for the project context from the attribute values, the programming instructions are further executable by the processor to apply the one or more rules for each of the plurality of methodologies to the attribute values of one or more root attributes of the project context.

25. The system as recited in claim 16, wherein, to generate an Agility score for the project context from the determined attribute values, the programming instructions are further executable by the processor to:
generate Agility scores for one or more pairs of the attributes; and
generate the Agility score for the project context from the Agility scores of the pairs of the attributes.

26. The system as recited in claim 16, wherein the project is a software development project.

27. The system as recited in claim 16, wherein the Agility curve includes a best-fit segment for each methodology.

28. The system as recited in claim 16, wherein the plurality of methodologies includes methodologies ranging from lightweight to heavyweight methodologies.

29. The system as recited in claim 16, wherein the plurality of methodologies includes one or more Agile methodologies.

30. The system as recited in claim 16, wherein the Agility curve is a normal distribution curve.

31. A system comprising:
means for generating an Agility score for a project context of a project from attribute values for one or more attributes of one or more components of the project context; and
means for applying the Agility score to an Agility curve for the project context to determine a best-fit methodology for the project from a plurality of methodologies.

32. The system as recited in claim 31, wherein the components include a people component, a process component, and a technology component.

33. The system as recited in claim 31, wherein the project is a software development project.

34. A computer-accessible medium comprising program instructions, wherein the program instructions are configured to implement:
determining attribute values for one or more attributes of one or more components of a project context of a project;
generating an Agility score for the project context from the determined attribute values; and
applying the Agility score to an Agility curve for the project context to determine a best-fit methodology for the project from a plurality of methodologies.

35. The computer-accessible medium as recited in claim 34, wherein the program instructions are further configured to implement scoring the project context against each of the plurality of methodologies.

36. The computer-accessible medium as recited in claim 34, wherein, in said generating an Agility score for the project context from the determined attribute values, the program instructions are further configured to implement scoring the project context against each of the plurality of methodologies according to a compatibility matrix.

37. The computer-accessible medium as recited in claim 34, wherein the program instructions are further configured to implement generating compatibility and incompatibility information for each of the plurality of methodologies with the project.

38. The computer-accessible medium as recited in claim 34, wherein the program instructions are further configured to implement determining one or more areas of compatibility and incompatibility with the project for the determined best-fit methodology.

39. The computer-accessible medium as recited in claim 34, wherein the components include a people component, a process component, and a technology component.

40. The computer-accessible medium as recited in claim 34, wherein, in said generating an Agility score for the project context from the determined attribute values, the program instructions are further configured to implement applying one or more rules for each of the plurality of methodologies to the determined attribute values of the one or more attributes.

41. The computer-accessible medium as recited in claim 40, wherein the rules include software development best practices rules.

42. The computer-accessible medium as recited in claim 40, wherein the program instructions are further configured to implement:
determining attribute values for one or more root attributes of the project context; and
wherein said generating an Agility score for the project context from the determined attribute values further comprises applying the one or more rules for each of the plurality of methodologies to the determined attribute values of the one or more root attributes.

43. The computer-accessible medium as recited in claim 34, wherein, in said generating an Agility score for the project context from the determined attribute values, the program instructions are further configured to implement:
generating Agility scores for one or more pairs of the attributes; and
generating the Agility score for the project context from the Agility scores of the pairs of the attributes.

44. The computer-accessible medium as recited in claim 34, wherein the project is a software development project.

45. The computer-accessible medium as recited in claim 34, wherein the Agility curve includes a best-fit segment for each methodology.

46. The computer-accessible medium as recited in claim 34, wherein the plurality of methodologies includes methodologies ranging from lightweight to heavyweight methodologies.

47. The computer-accessible medium as recited in claim 34, wherein the plurality of methodologies includes one or more Agile methodologies.

48. The computer-accessible medium as recited in claim 34, wherein the Agility curve is a normal distribution curve.
